(19) United States
(12) Patent Application Publication
(10) Pub. No.: US 2023/0303131 A1
(43) Pub. Date: Sep. 28, 2023

(54) LOCOMOTIVE ON-BOARD STORAGE AND DELIVERY OF GASEOUS FUEL

(71) Applicants: OPTIFUEL SYSTEMS LLC, Beaufort, SC (US); FMW SOLUTIONS LLC, Duluth, MN (US)

(72) Inventors: Scott D. MYERS, Beaufort, SC (US); Wolfgang FENGLER, Colorado Springs, CO (US)

(21) Appl. No.: 18/041,259

(22) PCT Filed: Aug. 12, 2021
(86) PCT No.: PCT/US2021/045705

§ 371 Date: Feb. 10, 2023

Related U.S. Application Data
(60) Provisional application No. 63/065,615, filed on Aug. 14, 2020.

(51) Int. Cl. B61C 17/02; B61C 17/06; B61C 5/00

(52) U.S. Cl. CPC B61C 17/02; B61C 17/06; B61C 5/00

(57) ABSTRACT

A locomotive is provided including a main deck extending along a longitudinal axis and supporting one or more prime movers configured to be powered at least partially by gaseous fuel; a first truck and a second truck axially spaced apart in the direction of the longitudinal axis, the first and second trucks supporting the main deck; and at least one fuel compartment integrated into the main deck along the longitudinal axis, the at least one fuel compartment comprising one or more supports configured to support loads from the main deck, and one or more storage wells adapted to store one or more storage tanks for storing the gaseous fuel.

### RELATED APPLICATIONS

This application claims the benefit of U.S. Provisional Application No. 63/065,615 filed Aug. 14, 2020, which is hereby incorporated herein by reference in its entirety.

### TECHNICAL FIELD

The present invention relates generally to locomotives, and more particularly to on-board storage and delivery of gaseous fuel for a locomotive.

### BACKGROUND

A growing trend is to power locomotives with less expensive, cleaner burning gaseous fuels, such as natural gas. However, even though locomotives are large vehicles, they typically have limited space available for the storage of such gaseous fuels due to the placement of various on-board power equipment, such as the engine, electrical generator, and the like. This situation is exacerbated with gaseous fuels such as natural gas, because even when stored as a cryogenic liquid, such fuels have substantially lower energy density than liquid fuels, such as diesel. Thus, these gaseous fuels (e.g., natural gas) typically require much larger storage tanks than liquid fuels (e.g., diesel) in order to produce the same refueling range. In addition, in systems where the alternative gaseous fuel is designed to burn in combination with the existing liquid fuel, then storage tanks for both fuels must be accommodated in the already-constrained space.

In order to improve the energy density of gaseous fuels, the gaseous fuel is commonly compressed for storage, often to pressures of several thousand pounds per square inch. Thus, the storage tanks containing these fuels are typically structurally reinforced pressure vessels, and the fuel lines and valves that deliver the fuel are typically exposed to this elevated tank pressure. In addition, the locomotive may experience significant shock and vibratory loading due to its operating environment, and may also experience significant environmental fluctuations, such as extreme changes in temperature. As such, the system for securing the fuel tanks and fuel delivery system should be able to withstand such loading and environmental variations over the multi-decade life of the locomotive.

### SUMMARY

While gaseous fuel may provide advantages in fuel cost and/or emissions reductions for locomotives, such alternative fuel presents significant challenges in fuel storage and efficiency in refueling operations due to the significantly lower energy density of the gaseous fuel.

Accordingly, an aspect of the present disclosure provides one or more improvements in the storage and delivery of gaseous fuel for a locomotive.

More particularly, an aspect of the present disclosure provides at least one fuel compartment of a locomotive that is integrated into the locomotive's main deck to maximize the gaseous fuel storage capabilities of the locomotive.

According to an aspect of the present disclosure, a locomotive includes a main deck extending along a longitudinal axis and supporting one or more prime movers configured to be powered at least partially by gaseous fuel; a first truck and a second truck axially spaced apart in the direction of the longitudinal axis, the first and second trucks supporting the main deck; and at least one fuel compartment integrated into the main deck along the longitudinal axis, the at least one fuel compartment comprising one or more supports configured to support loads exerted on the main deck, and one or more storage wells adapted to store one or more storage tanks for storing the gaseous fuel.

Embodiments may include one or more of the following additional features, separately or in any combination.

In some embodiments, the main deck includes a first main deck portion supported by the first truck, and a second main deck portion supported by the second truck such that the first and second main deck portions are axially spaced apart along the longitudinal axis; and wherein, the at least one fuel compartment separates the first main deck portion from the second main deck portion.

In some embodiments, the at least one fuel compartment spans along the longitudinal axis to bridge the first main deck portion with the second main deck portion.

In some embodiments, the at least one fuel compartment comprises at least two fuel compartments arranged axially relative to each other along the longitudinal axis.

In some embodiments, the at least one fuel compartment comprises at least two fuel compartments arranged laterally relative to each other in a direction transverse to the longitudinal axis.

In some embodiments, the at least one fuel compartment comprises an array of fuel compartments arranged adjacently to each other in the longitudinal direction and in a direction transverse to the longitudinal direction.

In some embodiments, the one or more supports of each fuel compartment comprise at least two supports laterally spaced apart relative to the longitudinal axis, each of the at least two supports extending along the longitudinal axis and defining the storage well therebetween.

In some embodiments, the storage wells are configured with a length along the longitudinal axis that is greater than a width transverse to the longitudinal axis, such that the storage tank is arranged in the longitudinal direction.

In some embodiments, the locomotive further comprises one or more additional storage wells mounted below the at least one fuel compartment.

In some embodiments, the one or more additional storage wells are arranged between the first and second trucks.

In some embodiments, the one or more additional storage wells are arranged such that the respective one or more storage tanks extend in the longitudinal direction.

In some embodiments, the at least one fuel compartment and/or the at least one additional fuel compartment includes a plurality of fuel compartments, the plurality of fuel compartments being adapted for different types of tanks, different diameters of tanks, different lengths of tanks, different pressure levels of tanks, different environmental conditions of tanks, and/or different flow control equipment of the tanks.

In some embodiments, the one or more supports of the fuel compartment support at least a portion of the prime mover and/or a battery for powering the locomotive.

In some embodiments, the prime mover and/or the battery are supported on top of the one or more supports of the at least one fuel compartment.

In some embodiments, the one or more prime movers includes a gaseous-fuel powered engine, such as a natural gas powered engine, a bio-methane powered engine, or a hydrogen powered fuel cell.

In some embodiments, each of the one or more prime movers is contained within a modular enclosure, each of the respective modular enclosures corresponding to a respective battery pack and having a fan.

In some embodiments, comprising the one or more storage tanks, wherein the one or more storage tanks are pressure vessels containing compressed gas.

According to another aspect of the disclosure, a method for integrating at least one fuel compartment into a main deck of a locomotive, includes: (i) providing the locomotive with the main deck; (ii) separating the main deck into at least a first main deck portion and a second main deck portion; and (iii) forming at least one fuel compartment between the first deck portion and the second deck portion.

The following description and the annexed drawings set forth certain illustrative embodiments of the invention. These embodiments are indicative, however, of but a few of the various ways in which the principles of the invention may be employed. Other objects, advantages and novel features according to aspects of the invention will become apparent from the following detailed description when considered in conjunction with the drawings.

### BRIEF DESCRIPTION OF THE DRAWINGS

The annexed drawings, which are not necessarily to scale, show various aspects of the invention.

FIG. 1 is a side view of an exemplary locomotive including exemplary fuel compartments integrated into the main deck of the locomotive in accordance with an embodiment of the present disclosure.

FIG. 2 is a perspective view of the locomotive in FIG. 1.

FIG. 3 is a top plan view of the locomotive in FIG. 1 with a top portion of the locomotive removed to show an exemplary arrangement of fuel compartments having fuel storage tanks.

FIG. 4 is a bottom plan view of the locomotive in FIG. 1.

FIG. 5 is a top plan view of another exemplary embodiment of a locomotive with a top portion of the locomotive removed to show another exemplary arrangement of fuel compartments having fuel storage tanks.

FIG. 6 is a bottom plan view of the locomotive in FIG. 5

### DETAILED DESCRIPTION

The principles and aspects of the present disclosure have particular application to locomotives powered by gaseous fuel, including engines operating on a single fuel or a combination of fuels, such as compressed natural gas (CNG) alone, or which may be used in combination with diesel fuel and/or which may be used in conjunction with an electrical generator, and thus will be described below chiefly in this context. It is understood, however, that the principles and aspects of this disclosure may be applicable to other systems that use other low-energy-dense fuels, such as other gaseous fuels (e.g., renewable natural gas (RNG), bio-methane, hydrogen, etc.), particularly where it is desirable to provide on-board storage and delivery of such fuel.

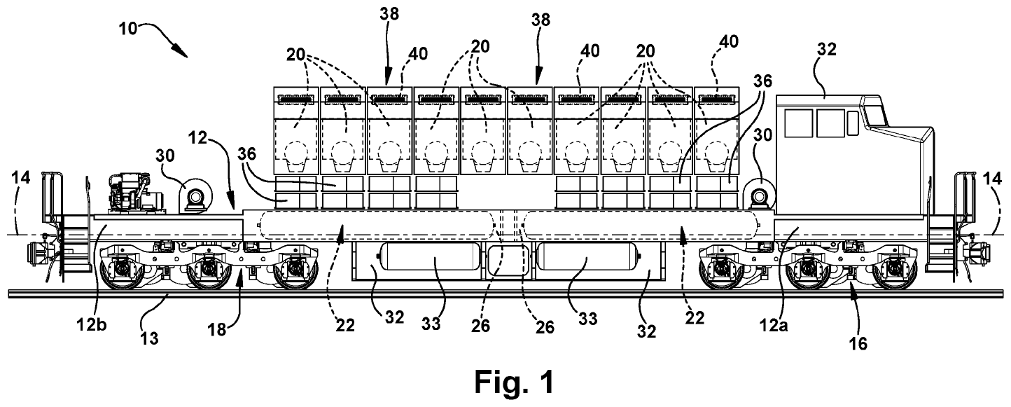

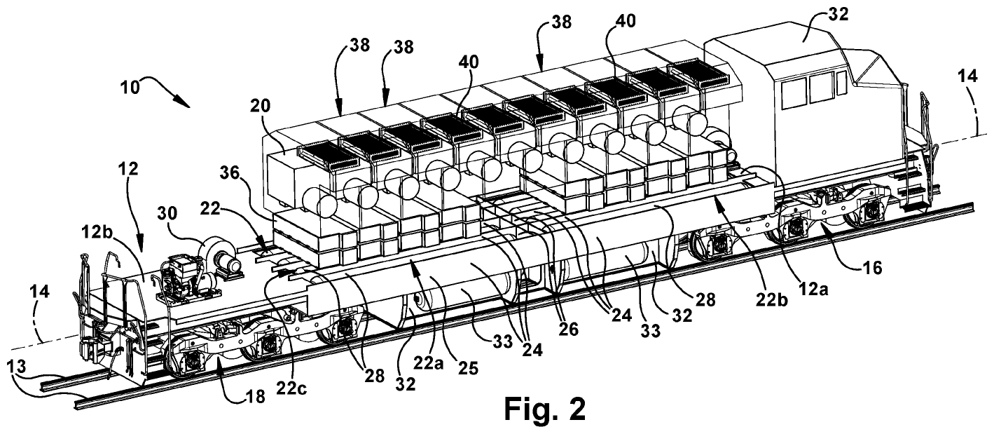

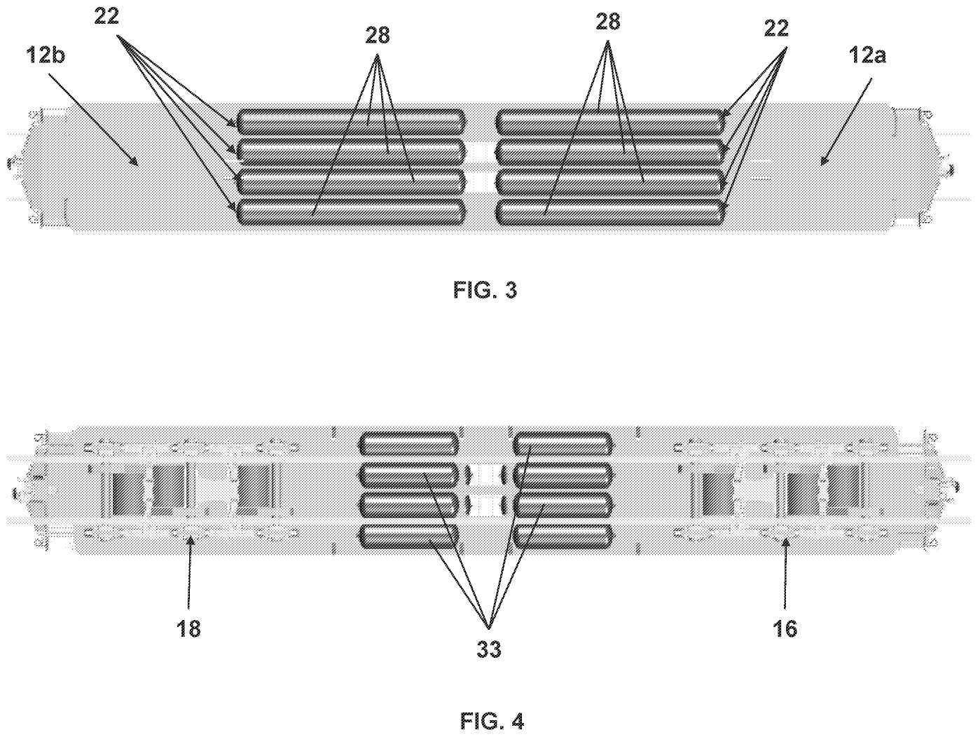

Referring to FIGS. 1-4, an exemplary locomotive 10 is shown in. The locomotive 10 includes a main deck 12 extending along a longitudinal axis 14 which is supported by at least a first truck 16 and a second truck 18 that are axially spaced apart from each other. The main deck 12 is configured to support one or more prime movers 20 on the trucks 16, 18. As shown, one or more fuel compartments 22 are integrated into the main deck 12 along the longitudinal axis 14. The one or more fuel compartments 22 generally include one or more supports 24 configured to support loads from the main deck 12, and also include one or more storage wells 26 adapted to store one or more storage tanks 28 for storing fuel, in particular gaseous fuel.

In the illustrated embodiment, the main deck 12 includes a first main deck portion 12a supported by the first truck 16, and a second main deck portion 12b supported by the second truck 18, such that the first and second main deck portions 12a, 12b are axially spaced apart from each other along the longitudinal axis 14. As shown, each of the main deck portions 12a, 12b may include a motor 30 for driving the trucks 16, 18. As shown, the trucks 16 and 18 are provided for riding on rails 19 of the track. In a manner well-known in the art, each truck 16 may include an assembly of axles, wheels, traction motors, gearing, suspension, and brakes. In the illustrated embodiment, the first main deck portion 12a includes a cabin 32 having controls for operation of the locomotive 10. In some embodiments, the locomotive may include more than one cabin 32.

As shown, the at least one fuel compartment 22, including corresponding supports 24 and storage wells 26, separates the first main deck portion 12a from the second main deck portion 12b. In exemplary embodiments, the at least one fuel compartment 22, such as a plurality of fuel compartments, spans along the longitudinal axis 14 to bridge the first main deck portion 12a with the second main deck portion 12b. In this manner, the at least one fuel compartment 22 is configured to transmit the loads between the respective first and second main deck portions 12a and 12b when the locomotive is resting or in use.

In exemplary embodiments, the at least one fuel compartment 22 comprises at least two fuel compartments 22a and 22b arranged axially relative to each other along the longitudinal axis 14. In the illustrated embodiment, the fuel compartments 22a and 22b are adjacent to each other. Alternatively or additionally, the at least one fuel compartment 22 includes at least two fuel compartments 22a and 22c arranged laterally relative to each other in a direction transverse to the longitudinal axis 14. In the illustrated embodiment, the fuel compartments 22a and 22c are adjacent to each other. In exemplary embodiments the at least one fuel compartment comprises an array of fuel compartments 22 arranged adjacently to each other in the longitudinal direction and in a direction transverse to the longitudinal direction, for example. More than two such fuel compartments 22 may be provided in the axial direction or transverse direction, such as 2=4 array in the illustrated embodiment.

In exemplary embodiments, each fuel compartment 22 includes at least two supports 24 laterally spaced apart relative to the longitudinal axis 14, in which each of these supports 24 extend along the longitudinal axis 14 and define at least a portion of the storage well 26 therebetween. In the illustrated embodiment, the storage wells 26 are configured with a length along the longitudinal axis 14 that is greater than a width transverse to the longitudinal axis, such that the storage tanks 28 are arranged in the longitudinal direction 14. Such an arrangement of the tanks 28 may reduce the overall number of tanks and the corresponding plumbing involved. Generally, the storage wells 26 may be formed as an enclosure, such as in a parallelepiped form, with suitable walls 25 for enclosing the tanks 28. The walls 25 may be formed by the supports 24 or may extend between supports 24.

In exemplary embodiments, the locomotive 10 may further include one or more additional storage wells 32 mounted below the one or more fuel compartments 22 integrated into the main frame 12. As shown, the one or more additional storage wells 32 may be arranged between the first and second trucks 16, 18. The one or more additional storage wells 32 may be arranged such that the additional fuel storage tanks 33 stored in the wells 32 extend in the longitudinal direction. Such a design in which the additional tanks 33 straddle a bottom floor of the fuel compartment(s) 22 enables the tanks 28 in the storage wells 26 to be much longer with minimal impact on the space above for the engine modules, batteries and the like.

In exemplary embodiments, the fuel compartment(s) 22 and/or 32 may include one or more different types of storage wells adapted for different types of tanks, different diameters of tanks, different lengths of tanks, different pressure levels of tanks, different environmental conditions of tanks, and/or different flow control equipment of the tanks. This may be the case where different types of prime movers 20 are utilized that operate on different types of fuel, for example. Generally, the fuel compartment(s) 22 and/or 32 may be adapted to store sufficient gaseous fuel to enable the locomotive to operate between regular refueling intervals without a tender car coupled to the locomotive 10. The gaseous fuel storage may be sufficient to allow locomotive operations to maintain typical liquid refueling intervals.

The respective storage tanks 28 and/or 33 may have any suitable form for storing the desired fuel. For example, at least some of the tanks 28 and/or 33 may contain compressed natural gas that may be pressurized to about 3,000 psi or greater, such as about 4,000 psi to 4,700 psi, or more. The fuel storage tanks 28 and/or 33 may therefore be configured as pressure vessels having sufficient strength to contain the pressurized gas. For example, the pressure vessels may be formed as an all-metal construction, a mostly metal construction with fiber-reinforced overwrap, a metal liner with full fiber-reinforced composite overwrap for carrying most of the load, a metal-free construction with plastic liner and full fiber-reinforced composite overwrap, or an all fiber-reinforced composite construction that is liner-free.

As would be understood by those having ordinary skill in the art, each tank 28 and/or 33 may have suitable inlet/outlet ports for supplying and/or refilling the gaseous fuel. The locomotive, and in particular the fuel compartment(s), also include a fuel supply system. The fuel supply system includes fluid conduits that fluidly connect to the inlet/outlet port(s) of the tanks 28 and/or 33 to the prime movers 20. The conduits may include rigid and/or flexible fluid conduits for delivery of the gaseous fuel to required locations within the locomotive. The system may provide for the pressure regulation of gaseous fuel for delivery to the prime mover. The system may provide for automatic release to the atmosphere of gaseous fuel should leakage or other such conditions occur. The system may include automatic electronic shutoff valves on each fuel tank that can be actuated by a control system. The system may include gaseous fuel detection sensor(s) to detect elevated levels of the gaseous fuel in the air.

The respective tanks 28 and/or 33 may be mounted in the respective fuel compartments 22, 32 in any suitable manner to withstand the vibration and other environmental factors experienced by the locomotive 10. For example, the tanks may be mounted on mounts, such as bosses, or may be stored in cradles disposed within the storage wells. Suitable damping members, such as isolation bearings, resilient materials, or the like, may be used in conjunction with mounting the tanks 28 and/or 33 to minimize the effects of vibration on the tanks.

As discussed above, the one or more supports 24 generally are configured to support loads from the main deck 12, such as to distribute or transfer loads between the first and second main deck portions 12a, 12b, and to support any components of the locomotive above the fuel compartment(s) 22. In exemplary embodiments, the supports 24 may be configured as I-beams or other suitable structure(s) configured to support the required loads. Each the supports 24 may be configured as a wall, or may support walls 25, for forming a portion of the storage well 26 and separating the one or more storage tanks 28. The supports may be made of any suitable material, such as steel. The supports 24 may be welded to the first and second main deck portions 12a, 12b, or may be operatively coupled to the base in a suitable manner. It is understood that the number and location of the supports 24 may be chosen as desired depending on overall load, load distribution, number of desired fuel tanks, among other considerations understood by those having skill in the art. It is also understood that although a plurality of supports 24 are shown, the support structure may be configured as a unitary or sectional frame that extends between the first and second main deck portions 12a, 12b so as to exhibits sufficient load bearing capability.

As shown in the illustrated embodiment, the prime mover(s) 20 and/or one or more batteries 36 are supported on top of the supports 24 of the fuel compartments 22. In exemplary embodiments, each of the prime movers 20 is contained within a modular enclosure 38, and one or more or each of the respective modular enclosures 38 may corresponding to a respective battery pack 36. Also as shown, each modular enclosure 38 may include a fan 40. In exemplary embodiments, one or more or all of the modular enclosures 38 are the same, such as with the same type of prime mover 20; or one or more or all of the modular enclosures 38 may be different, such as with different types of prime movers 20 which may operate on different types of fuels, or have different power levels, for example). Although not shown, each fuel compartment 22 may include a ceiling which forms a floor to support the prime mover(s) 20 (e.g., modules 38) and/or batteries 36, for example. The ceiling may be sealed so as to restrict leaked gas from the one or more storage tanks 28 from passing into the prime movers 20 and/or batteries 36.

In exemplary embodiments, at least one of the prime movers 20 is powered by a gaseous fuel from one or more of the storage tanks 28 and/or 33, such as by natural gas (e.g., LNG or RNG), hydrogen, methane, bio-methane, or a combination of such gaseous fuels, or any other suitable gaseous fuel. The term “powered by” as used herein means that the prime mover may be wholly powered by the gaseous fuel, or may be partially powered by the gaseous fuel, such as in combination with diesel or other liquid fuel. One or more or all of the prime movers 20 may be the same type of prime mover, or one or more or all of the prime movers 20 may be a different type of prime mover. One or more or all of the prime movers 20 may include an internal combustion engine that is powered by the gaseous fuel, such as a natural gas or natural gas-diesel hybrid engine, for example. Alternatively or additionally, one or more or all of the prime movers 20 may include a fuel cell powered by the gaseous fuel, such as a hydrogen fuel cell, for example.

In a known-manner, one or more or all of the prime movers 20 may be operatively coupled to one or more electrical generators, which may provide alternating current or direct current to the traction motors in the truck assemblies, which transmit power to the wheels. Alternatively or additionally, the engines may be operatively coupled to a hydraulic system for torque transmission and/or for enabling energy recuperation. The locomotive 10 also may include other power-generation equipment, which may be contained in one or more modules, for example. Such power-generation equipment may include an electronics module including one or more electrical generators powered by the prime mover(s) 20, such as one or more alternators that produce alternating current for powering the traction motors, and which store energy in the batteries 36. Generally, the locomotive 10 may be a hybrid (e.g. gaseous fuel, such as NG) plus other fuel (e.g., liquid petroleum-based fuel, such as gasoline or diesel); a hybrid-electric, and/or gaseous (e.g., NG)-electric, or gaseous-only fuel (e.g., NG only) locomotive 10.

In exemplary embodiments, the locomotive 10 is configured as a switcher locomotive that operates on a switcher line for moving and assembling or disassembling railroad cars in the train consist. The switcher locomotive typically operates over shorter distances, and the exemplary fuel compartment(s) 22 may be configured to store sufficient gaseous fuel to enable the switcher locomotive to operate between regular refueling intervals without a separate tender car coupled to the switcher locomotive.

In exemplary embodiments, the fuel compartment(s) 22 may together be formed as a modular unit that is mountable between the first and second main deck portions 12a, 12b.

In exemplary embodiments, the fuel compartment(s) 22 may be used for retrofitting pre-existing locomotives. For example, a pre-existing locomotive having a main engine deck and trucks may be sectioned to separate the main deck into the first and second parts 12a, 12b. The fuel compartment(s) 22 may then be formed between these main deck parts 12a, 12b. In this manner, the middle section of an existing old frame may be eliminated and replaced with a new middle section having fuel compartments 22 welded into the old frame.

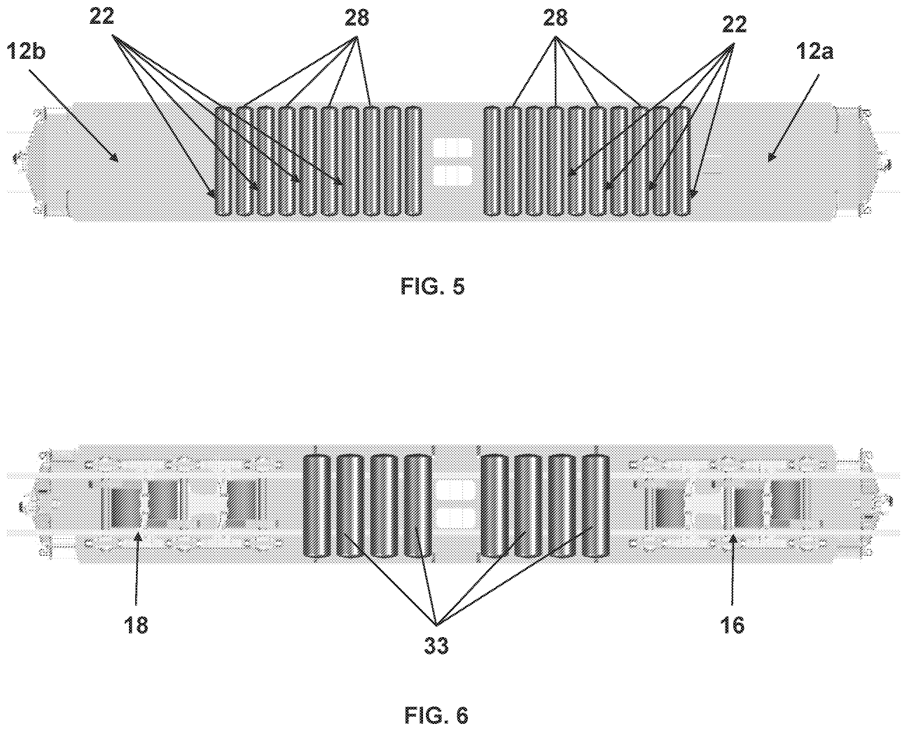

While an exemplary form of the locomotive 10 has been described above, it should be apparent to those having ordinary skill in the art that alternative configurations also could be employed. For example, referring to FIGS. 5 and 6, another exemplary arrangement of the fuel compartments 22 containing fuel storage tanks 28 is shown, in which the compartments and tanks extend laterally and are longitudinally spaced apart. Also as shown, the fuel tanks 33 also may extend laterally. It is understood, of course, that other variations could be employed, including any combination of lateral or longitudinal arrangements of one or more of the tanks 28 and/or one or more of the tanks 33.

It is to be understood that terms such as “top,” “bottom,” “upper,” “lower,” “left,” “right,” “front,” “rear,” “forward,” “rearward,” and the like as used herein may refer to an arbitrary frame of reference, rather than to the ordinary gravitational frame of reference.

An “operable connection” or “operative connection”, or a connection by which entities are “operably connected,” is one in which the entities are connected in such a way that the entities may perform as intended. An operable connection may be a direct connection or an indirect connection in which an intermediate entity or entities cooperate or otherwise are part of the connection or are in between the operably connected entities. An operable connection or coupling may include the entities being integral and unitary with each other.

The phrase “and/or” should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. A locomotive comprising:
a main deck extending along a longitudinal axis and supporting one or more prime movers configured to be powered at least partially by gaseous fuel;
a first truck and a second truck axially spaced apart in the direction of the longitudinal axis, the first and second trucks supporting the main deck; and
at least one fuel compartment integrated into the main deck along the longitudinal axis, the at least one fuel compartment comprising one or more supports configured to support loads exerted on the main deck, and one or more storage wells adapted to store one or more storage tanks for storing the gaseous fuel.

2. The locomotive according to claim 1,
wherein the main deck includes a first main deck portion supported by the first truck, and a second main deck portion supported by the second truck such that the first and second main deck portions are axially spaced apart along the longitudinal axis; and
wherein the at least one fuel compartment separates the first main deck portion from the second main deck portion.

3. The locomotive according to claim 2, wherein the at least one fuel compartment spans along the longitudinal axis to bridge the first main deck portion with the second main deck portion.

4. The locomotive according to claim 1, or any other preceding claim, wherein the at least one fuel compartment comprises at least two fuel compartments arranged axially relative to each other along the longitudinal axis.

5. The locomotive according to claim 1, wherein the at least one fuel compartment comprises at least two fuel compartments arranged laterally relative to each other in a direction transverse to the longitudinal axis.

6. The locomotive according to claim 1, wherein the at least one fuel compartment comprises an array of fuel compartments arranged adjacently to each other in the longitudinal direction and in a direction transverse to the longitudinal direction.

7. The locomotive according to claim 1, wherein the one or more supports of each fuel compartment comprise at least two supports laterally spaced apart relative to the longitudinal axis, each of the at least two supports extending along the longitudinal axis and defining the storage well therebetween.

8. The locomotive according to claim 1, wherein the storage wells are configured with a length along the longitudinal axis that is greater than a width transverse to the longitudinal axis, such that the storage tank is arranged in the longitudinal direction.

9. The locomotive according to claim 1, wherein the locomotive further comprises one or more additional storage wells mounted below the at least one fuel compartment.

10. The locomotive according to claim 1, the one or more additional storage wells are arranged between the first and second trucks.

11. The locomotive according to claim 1, wherein the one or more additional storage wells are arranged such that the respective one or more storage tanks extend in the longitudinal direction.

12. The locomotive according to claim 1, wherein the at least one fuel compartment and/or the at least one additional fuel compartment includes a plurality of fuel compartments, the plurality of fuel compartments being adapted for different types of tanks, different diameters of tanks, different lengths of tanks, different pressure levels of tanks, different environmental conditions of tanks, and/or different flow control equipment of the tanks.

13. The locomotive according to claim 1,
wherein the one or more supports of the fuel compartment support at least a portion of the prime mover and/or a battery for powering the locomotive.

14. The locomotive according to claim 1, wherein the prime mover and/or the battery are supported on top of the one or more supports of the at least one fuel compartment.

15. The locomotive according to claim 1, wherein the one or more prime movers includes a gaseous-fuel powered engine, such as a natural gas powered engine, a bio-methane powered engine, or a hydrogen powered fuel cell.

16. The locomotive according to claim 1, wherein each of the one or more prime movers is contained within a modular enclosure, each of the respective modular enclosures corresponding to a respective battery pack and having a fan.

17. The locomotive according to claim 1, further comprising the one or more storage tanks, wherein the one or more storage tanks are pressure vessels containing compressed gas.

18. A method for integrating at least one fuel compartment into a main deck of a locomotive, comprising:
providing the locomotive with the main deck;
separating the main deck into at least a first main deck portion and a second main deck portion; and
forming at least one fuel compartment between the first deck portion and the second deck portion.
